(19) United States
(12) Patent Application Publication
(10) Pub. No.: US 2017/0002136 A1
(43) Pub. Date: Jan. 5, 2017

(54) POLYMER COMPOSITIONS PRODUCED FROM BIOBASED ETHANOL

(71) Applicant: NOVOMER, INC., Waltham, MA (US)

(72) Inventor: Sadesh Sookraj, Waltham (ZA)

(21) Appl. No.: 15/199,439

(22) Filed: Jun. 30, 2016

Related U.S. Application Data
(60) Provisional application No. 62/187,693, filed on Jul. 1, 2015.
(60) Provisional application No. 62/188,372, filed on Jul. 2, 2015.

(51) Int. Cl. C08G 63/183

(52) U.S. Cl. CPC C08G 63/183

(57) ABSTRACT

The present invention provides terephthalic acid in which two of the aromatic ring carbons are derived from ethanol. The present invention also provides PET, PTT, and PBT polymer compositions, and plastic molding compositions and manufactured goods thereof, wherein each repeat unit in a polymer composition can comprise four ethanol-derived carbon atoms.

### CROSS REFERENCE TO RELATED TO APPLICATIONS

The present application claims benefit from U.S. Ser. No. 62/187,693, filed Jul. 1, 2015 and U.S. Ser. No. 62/188,372 filed Jul. 2, 2015, which is hereby incorporated by reference in its entirety as if fully restated herein.

### BACKGROUND OF THE INVENTION

Terephthalic acid (TPA) is used in conjunction with isophthalic acid (IPA) to produce polyethylene terephthalate (PET) which is used extensively in consumer goods packaging, most prominently in the now ubiquitous plastic water bottles.

There is strong demand from consumers and consumer goods companies for sustainable alternatives to petroleum-based plastics for packaging applications. Indeed Coca Cola® and others have recently introduced PET based biobased monoethylene glycol (MEG). The resulting bottles are branded as “Plant Bottle™” and have been well received in the marketplace. Unfortunately, since about 70% of the mass in PET derives from terephthalic and isophthalic acids, replacing petroleum-sourced MEG with biobased material yields PET that is only about 30% biobased. There is considerable interest in biobased IPA and TPA, or esters thereof, and PET.

### SUMMARY OF THE INVENTION

The present invention addresses the problem that current biobased routes to terephthalic acid are carbon inefficient. Ethanol production provides an efficient biobased chemical process, and ethanol can be utilized as a primary feedstock for terephthalic acid production.

In the ethanol-involved terephthalic acid production, one of the two ethanol-derived carbon atoms will be the carbon atom in the terephthalic acid that is bonded to a carboxy group.

In one aspect, provided herein is terephthalic acid in which two of the aromatic ring carbons are derived from biobased ethanol. This is a novel composition that can fulfill a market need for sustainable terephthalic acid having a low carbon footprint.

Ethanol can be converted to monoethylene glycol. Thus, biobased ethanol can produce biobased monoethylene glycol, wherein both carbons are derived from biobased ethanol. A further reaction between the biobased terephthalic acid, wherein two of the aromatic ring carbons are derived from biobased ethanol, and the biobased monoethylene glycol, wherein both carbons are derived from biobased ethanol, results in a polyethylene terephthalate (PET) composition, polytrimethyl terephthalate (PTT) composition, polbutyylene terephthalate (PBT) composition or a co-polymer comprising PET, PTT and/or PBT that has the unprecedented feature of including at least two and in other embodiments four or more ethanol-derived carbon atoms in each carbon alkylene terephthalate repeat unit.

Thus, in one aspect this invention is a polymer composition comprising polyalkyleneterephthalate polymer chains, the composition characterized in that, in at least a 10% of the polymer chains, at least two of the carbon atoms in each alkylene terephthalate repeat unit of the polymer chains are derived from ethanol and the polyalkyleneterephthalate polymer chains consist of polyethylene terephthalate polymer chains having 10 carbon atoms in polythylene terephthalate repeat units; polytrimethylene terephthalate polymer chains having 11 carbon atoms in polytrimethylene terephthalate repeat units; or polybutylene terephthalate polymer chains having 12 carbon atoms in polybutylene terephthalate repeat units.

In another aspect the at least a 10% of the polymer chains of the polyalkyleneterephthalate polymer have at least two carbons atoms in each repeat unit in the aromatic ring.

In another aspect the at least a 10% of the polymer chains of the polyalkyleneterephthalate polymer have at least four of the carbon atoms in each alkylene terephthalate repeat unit of the polymer chains derived from ethanol.

In another aspect the at least a 10% of the polymer chains of the polyalkyleneterephthalate polymer have at least four carbon atoms derived from ethanol that include two methylene carbon atoms in the alkylene moiety, and two of the carbon atoms in the aromatic ring of the terephthalate moiety.

In another aspect the at least a 10% of the polymer chains of the polyalkyleneterephthalate polymer have one of the carbon atoms in the aromatic ring that derived from ethanol and directly bonded to a carboxy group or to a hydrogen atom.

In another aspect the at least a 10% of the polymer chains of the polyalkyleneterephthalate polymer have at least two carbon atoms in the aromatic ring that are derived from ethanol and are adjacent to each other in the ring.

In another aspect the at least a 10% of the polymer chains of the polyalkyleneterephthalate polymer have one of the at least two ethanol derived carbon atoms in the aromatic ring directly bonded to a carboxy group.

In another aspect the at least a 10% of the polymer chains of the polyalkyleneterephthalate polymer have at least two ethanol derived carbon atoms in the aromatic ring that are not both directly bonded to hydrogen atoms.

In another aspect the at least a 10% of the polymer chains of the polyalkyleneterephthalate polymer have at least two ethanol derived carbon atoms in the aromatic ring and the composition contains a mixture of alkylene terephthalate repeat units that differ with respect to the position of the carbon atoms that are derived from ethanol in the aromatic rings.

In another aspect the at least a 10% of the polymer chains of the polyalkyleneterephthalate polymer having at least two ethanol derived carbon atoms in the aromatic ring contain at least 20%, at least 30%, at least 50%, at least 75%, or at least 90% of all polyalkylene terephthalate polymer chains in the composition.

In another aspect the at least a 10% of the polymer chains of the polyalkyleneterephthalate polymer have terephthalate repeat units with alkylene carbon atoms derived from ethanol, but none of the aromatic ring carbons derived from ethanol.

In another aspect the at least a 10% of the polymer chains of the polyalkyleneterephthalate polymer have at least four carbon atoms derived from ethanol that include the two methylene carbon atoms in the alkylene glycol unit, and two of the carbon atoms in the aromatic ring.

In another aspect this invention is a polymer composition comprising polyalkyleneterephthalate polymer chains that have in at least a 10% of the polymer chains, at least four of the carbon atoms in each alkylene terephthalate repeat unit of the polymer chains are derived from ethanol and the polyalkyleneterephthalate polymer chains consist of polyethylene terephthalate polymer chains having 10 carbon atoms in polythylene terephthalate repeat units; polytrimethylene terephthalate polymer chains having 11 carbon atoms in polytrimethylene terephthalate repeat units; or polybutylene terephthalate polymer chains having 12 carbon atoms in polybutylene terephthalate repeat units.

In other aspects of this invention the polymer composition comprising polyalkyleneterephthalate polymer chains that have in at least a 10% of the polymer chains, at least four of the carbon atoms in each alkylene terephthalate repeat unit of the polymer chains that are derived from ethanol may also have: one of the carbon atoms that is derived from ethanol directly bonded to a carboxy group or to a hydrogen atom; at least two carbon atoms derived from ethanol adjacent to each other in the aromatic ring; one of the ethanol derived carbon atoms in the aromatic ring and directly bonded to a carboxy group, or two ethanol derived carbon atoms in the aromatic ring, but in positions where both of them are not directly bonded to hydrogen atoms.

The present PET compositions may consist exclusively of ethanol-derived polyethylene terephthalate repeat units, or may be blends with either traditional 100% petroleum-based PET, or PET derived from bio-MEG and petroleum-based terephthalic acid.

In some embodiments, the present invention provides PET compositions wherein the polymer chains contain a mixture of ethylene terephthalate moieties, only some of which contain ethanol-derived carbon atoms. Such PET compositions could be made by blending terephthalic acid from multiple sources during PET production, or could arise during the PET lifecycle either through transesterification during co-extrusion with PET from other sources during manufacturing steps or through re-processing of post-consumer PET.

Accordingly, in one aspect, provided herein is a polymer composition comprising polyethylene terephthalate polymer chains, the composition characterized in that, in at least a fraction of the polymer chains, four of the ten carbon atoms in each ethylene terephthalate repeat unit of the polymer chains are derived from ethanol.

In another aspect, the present invention provides a polymer composition comprising polyethylene terephthalate polymer chains wherein four of the ten carbon atoms in at least a fraction of the ethylene terephthalate repeat units in the polymer chains are derived from ethanol.

In another aspect, the present invention provides a polymer composition comprising polyethylene terephthalate polymer chains, the composition characterized in that, in at least a fraction of the polymer chains, at least two of the carbon atoms in the aromatic ring of each ethylene terephthalate repeat unit in the polymer chains are derived from ethanol.

In another aspect, the present invention provides a polymer composition comprising polyethylene terephthalate polymer chains wherein two of the carbon atoms in the aromatic ring of at least a fraction of the ethylene terephthalate repeat units in the polymer chains are derived from ethanol.

In another aspect, the present invention provides a polymer composition comprising polyethylene terephthalate polymer chains, the composition characterized in that four of the ten carbon atoms in at least a fraction of the ethylene terephthalate repeat units in the composition are derived from ethanol.

In some embodiments, the carboxy groups of the PET are derived from carbon monoxide that is present in the ethanol-involved terephthalic acid production.

Ethanol can also be converted to trimethylene glycol and butylene glycol. Thus, biobased ethanol can produce biobased trimethylene glycol and butylene glycol, in each of which two carbons are derived from biobased ethanol. A further reaction between the biobased terephthalic acid, wherein two of the aromatic ring carbons are derived from biobased ethanol, and the biobased trimethylene glycol or butylene glycol, in each of which two carbons are derived from biobased ethanol, results in a polytrimethylene terephthalate composition or a polybutylene terephthalate composition, respectively, which has the unprecedented feature of including four ethanol-derived carbon atoms in each eleven carbon trimethylene terephthalate repeat unit, or in each twelve carbon butylene terephthalate repeat unit.

The present polytrimethylene terephthalate compositions can consist exclusively of ethanol-derived polytrimethylene terephthalate repeat units, or they can be blends with traditional 100% petroleum-based polytrimethylene terephthalate. The present polybutylene terephthalate compositions can consist exclusively of ethanol-derived polybutylene terephthalate repeat units, or they can be blends with traditional 100% petroleum-based polybutylene terephthalate.

In some embodiments, the present invention provides polytrimethylene terephthalate compositions wherein the polymer chains contain a mixture of trimethylene terephthalate moieties, only some of which contain ethanol-derived carbon atoms. Such polytrimethylene terephthalate compositions could be made by blending terephthalic acid from multiple sources during polytrimethylene terephthalate production, or could arise during the polytrimethylene terephthalate lifecycle either through transesterification during co-extrusion with polytrimethylene terephthalate from other sources during manufacturing steps or through re-processing of post-consumer polytrimethylene terephthalate.

In some embodiments, the present invention provides polybutylene terephthalate compositions wherein the polymer chains contain a mixture of butylene terephthalate moieties, only some of which contain ethanol-derived carbon atoms. Such polybutylene terephthalate compositions could be made by blending terephthalic acid from multiple sources during polybutylene terephthalate production, or could arise during the polybutylene terephthalate lifecycle either through transesterification during co-extrusion with polybutylene terephthalate from other sources during manufacturing steps or through re-processing of post-consumer polybutylene terephthalate.

Accordingly, in another aspect, provided herein is a polymer composition comprising polytrimethylene terephthalate polymer chains, the composition characterized in that, in at least a fraction of the polymer chains, four of the eleven carbon atoms in each trimethylene terephthalate repeat unit of the polymer chains are derived from ethanol.

In another aspect, the present invention provides a polymer composition comprising polytrimethylene terephthalate polymer chains wherein four of the eleven carbon atoms in at least a fraction of the trimethylene terephthalate repeat units in the polymer chains are derived from ethanol.

In another aspect, the present invention provides a polymer composition comprising polytrimethylene terephthalate polymer chains, the composition characterized in that, in at least a fraction of the polymer chains, at least two of the carbon atoms in the aromatic ring of each trimethylene terephthalate repeat unit in the polymer chains are derived from ethanol.

In another aspect, the present invention provides a polymer composition comprising polytrimethylene terephthalate polymer chains wherein two of the carbon atoms in the aromatic ring of at least a fraction of the trimethylene terephthalate repeat units in the polymer chains are derived from ethanol.

In another aspect, the present invention provides a polymer composition comprising polytrimethylene terephthalate polymer chains, the composition characterized in that four of the eleven carbon atoms in at least a fraction of the trimethylene terephthalate repeat units in the composition are derived from ethanol.

In some embodiments, the carboxy carbon atoms of the polytrimethylene terephthalate are derived from carbon monoxide that is present in the ethanol-involved terephthalic acid production.

In another aspect, provided herein is a polymer composition comprising polybutylene terephthalate polymer chains, the composition characterized in that, in at least a fraction of the polymer chains, four of the twelve carbon atoms in each butylene terephthalate repeat unit of the polymer chains are derived from ethanol.

In another aspect, the present invention provides a polymer composition comprising polybutylene terephthalate polymer chains wherein four of the twelve carbon atoms in at least a fraction of the butylene terephthalate repeat units in the polymer chains are derived from ethanol.

In another aspect, the present invention provides a polymer composition comprising polybutylene terephthalate polymer chains, the composition characterized in that, in at least a fraction of the polymer chains, at least two of the carbon atoms in the aromatic ring of each butylene terephthalate repeat unit in the polymer chains are derived from ethanol.

In another aspect, the present invention provides a polymer composition comprising polybutylene terephthalate polymer chains wherein two of the carbon atoms in the aromatic ring of at least a fraction of the butylene terephthalate repeat units in the polymer chains are derived from ethanol.

In another aspect, the present invention provides a polymer composition comprising polybutylene terephthalate polymer chains, the composition characterized in that four of the twelve carbon atoms in at least a fraction of the butylene terephthalate repeat units in the composition are derived from ethanol.

In some embodiments, the carboxy groups of the polybutylene terephthalate are derived from carbon monoxide that is present in the ethanol-involved terephthalic acid production.

In another aspect, provided herein is a plastic molding composition comprising a polymer composition as described herein.

In another aspect, provided herein is a manufacture good comprising a polymer composition as described herein.

### DEFINITIONS

The term “polymer”, as used herein, refers to a molecule of high relative molecular mass, the structure of which comprises the multiple repetition of units derived, actually or conceptually, from molecules of low relative molecular mass. The term “polymer” further refers to copolymers derived from more than one monomer. Thus, each instance of the term polymer, as used herein, also refers to a copolymer.

Bio-based content: the bio-based content of a material is measured using the ASTM D6866 method, which allows the determination of the bio-based content of materials using radiocarbon analysis by accelerator mass spectrometry, liquid scintillation counting, and isotope mass spectrometry. When nitrogen in the atmosphere is struck by an ultraviolet light produced neutron, it loses a proton and forms carbon that has a molecular weight of 14, which is radioactive. This ¹⁴C is immediately oxidized into carbon dioxide, and represents a small, but measurable fraction of atmospheric carbon. Atmospheric carbon dioxide is cycled by green plants to make organic molecules during photosynthesis. The cycle is completed when the green plants or other forms of life metabolize the organic molecules producing carbon dioxide which is then able to return back to the atmosphere. Virtually all forms of life on Earth depend on this green plant production of organic molecules to produce the chemical energy that facilitates growth and reproduction. Therefore, the ¹⁴C that exists in the atmosphere becomes part of all life forms and their biological products. These renewably based organic molecules that biodegrade to carbon dioxide do not contribute to global warming because no net increase of carbon is emitted to the atmosphere. In contrast, fossil fuel-based carbon does not have the signature radiocarbon ratio of atmospheric carbon dioxide. See WO 2009/155086, incorporated herein by reference.

The application of ASTM D6866 to derive a “bio-based content” is built on the same concepts as radiocarbon dating, but without use of the age equations. The analysis is performed by deriving a ratio of the amount of radiocarbon (¹⁴C) in an unknown sample to that of a modern reference standard. The ratio is reported as a percentage, with the units “pMC” (percent modern carbon). If the material being analyzed is a mixture of present day radiocarbon and fossil carbon (containing no radiocarbon), then the pMC value obtained correlates directly to the amount of bio-based material present in the sample. The modern reference standard used in radiocarbon dating is a NIST (National Institute of Standards and Technology) standard with a known radiocarbon content equivalent approximately to the year AD 1950. The year AD 1950 was chosen because it represented a time prior to thermonuclear weapons testing which introduced large amounts of excess radiocarbon into the atmosphere with each explosion (termed “bomb carbon”). The AD 1950 reference represents 100 pMC. “Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. The distribution of bomb carbon has gradually decreased over time, with today's value being near 107.5 pMC. As a result, a fresh biomass material, such as corn, could result in a radiocarbon signature near 107.5 pMC.

Petroleum-based carbon does not have the signature radiocarbon ratio of atmospheric carbon dioxide. Research has noted that fossil fuels and petrochemicals have less than about 1 pMC, and typically less than about 0.1 pMC, for example, less than about 0.03 pMC. However, compounds derived entirely from renewable resources have at least about 95 percent modern carbon (pMC), they may have at least about 99 pMC, including about 100 pMC.

Combining fossil carbon with present day carbon into a material will result in a dilution of the present day pMC content. By presuming that 107.5 pMC represents present day bio-based materials and 0 pMC represents petroleum derivatives, the measured pMC value for that material will reflect the proportions of the two component types. A material derived 100% from present day biomass would give a radiocarbon signature near 107.5 pMC. If that material were diluted with 50% petroleum derivatives, it would give a radiocarbon signature near 54 pMC.

A bio-based content result is derived by assigning 100% equal to 107.5 pMC and 0% equal to 0 pMC. In this regard, a sample measuring 99 pMC will give an equivalent bio-based content result of 93%.

Assessment of the materials described herein according to the present embodiments is performed in accordance with ASTM D6866 revision 12 (i.e. ASTM D6866-12), the entirety of which is herein incorporated by reference. In some embodiments, the assessments are performed according to the procedures of Method B of ASTM-D6866-12. The mean values encompass an absolute range of 6% (plus and minus 3% on either side of the bio-based content value) to account for variations in end-component radiocarbon signatures. It is presumed that all materials are present day or fossil in origin and that the desired result is the amount of bio-based carbon “present” in the material, not the amount of bio-material “used” in the manufacturing process.

Other techniques for assessing the bio-based content of materials are described in U.S. Pat. Nos. 3,885,155, 4,427,884, 4,973,841, 5,438,194, and 5,661,299, and WO 2009/155086, each of which is incorporated herein by reference.

### DETAILED DESCRIPTION OF THE INVENTION

### Conversion Schemes

Schemes 1-3 below depict exemplary conversion schemes for preparing composition described herein.

Scheme 1 depicts conversions including that of ethanol to ethylene oxide, beta propiolactone, acrylic acid and/or maleic anhydride, and terephthalic acid (i.e., bio TPA) via, for example, the known Henkel process.

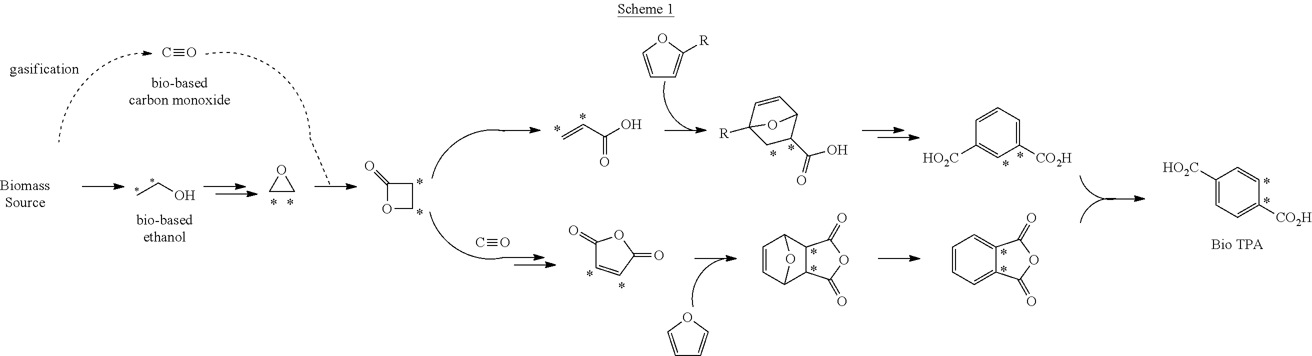

Scheme 2 depicts the conversion of bio TPA to DMTA and/or bis(2-hydroxyethyl)terephthalate.

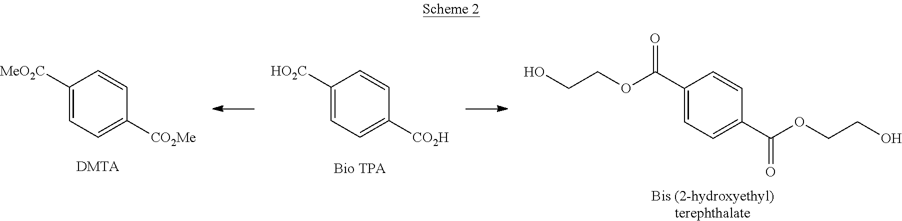

Scheme 3 depicts the conversion of ethanol to ethylene oxide and monoethylene glycol (MEG), which is combined with bio-TPA to make bio-PET.

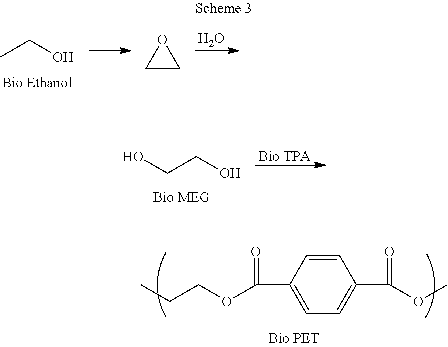

Methods of making beta propiolactone from the carbonylation of ethylene oxide are known in the art and include those described in WO 2013/063191 and WO 2014/004858.

Methods of making succinic anhydride from the carbonylation of ethylene oxide are known in the art and include those described in WO 2012/030619 and WO 2013/122905. Succinic anhydride is oxidized to maleic anhydride by known methods.

Methods of making acrylic acid from beta propiolactone are known in the art and include those described in WO 2013/126375, WO 2010/118128 and WO 2013/063191. The entire contents of each of the above publications is hereby incorporated by reference.

### Monomer Compositions

In one aspect, the present invention provides a monomer composition comprising terephthalic acid:

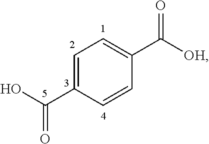 [SMILES: O=C(O)c1ccc(C(=O)O)cc1]

wherein two of the aromatic ring carbons are derived from ethanol.

In some embodiments, the ethanol is derived from a biological source (i.e., a biobased ethanol). In some embodiments, the biobased ethanol has a biobased content of 100%. In some embodiments, the biobased ethanol has a pMC of 107.5.

In some embodiments, one of the ethanol-derived carbon atoms in the terephthalic acid is bond to a carboxy group.

In some embodiments, the terephthalic acid has a biobased content of 25%. In some embodiments, the terephthalic acid has a pMC of 26.875.

### Polymer Compositions, and Plastic Molding Compositions and Manufactured Goods Thereof

Also provided herein are polymer compositions derived from the terephthalic acid compositions described above.

### PET Compositions, and Plastic Molding Compositions and Manufactured Goods Thereof

In one aspect, provided herein is a polymer composition comprising polyethylene terephthalate polymer chains, the composition characterized in that, in at least a fraction of the polymer chains, four of the ten carbon atoms in each ethylene terephthalate repeat unit of the polymer chains are derived from ethanol.

In some embodiments, the four carbon atoms derived from ethanol include the two methylene carbon atoms in the ethylene moiety, and two of the carbon atoms in the aromatic ring of the terephthalate moiety. In some embodiments, the composition contains a mixture of ethylene terephthalate repeat units that differ with respect to the position of the carbon atoms that are derived from ethanol in the aromatic rings.

In some embodiments, one of the carbon atoms in the aromatic ring that is derived from ethanol is directly bonded to a carboxy group.

In some embodiments, one of the carbon atoms in the aromatic ring that is derived from ethanol is directly bonded to a hydrogen atom.

In some embodiments, the two carbon atoms in the aromatic ring derived from ethanol are adjacent to each other in the ring. In some embodiments, one of the two carbon atoms in the aromatic ring derived from ethanol is directly bonded to a carboxy group. In some embodiments, the polymer composition comprises ethylene terephthalate repeat units wherein the carbon atoms in the aromatic ring derived from ethanol are not both directly bonded to hydrogen atoms.

In some embodiments, the composition comprises a mixture of polyethylene terephthalate polymer chains, some of which are characterized in that at least four of the ten carbon atoms in the repeat unit of the polymer chains are derived from ethanol, and some of which are characterized in that two or fewer of the ten carbon atoms in the repeat unit of the polymer chains are derived from ethanol. In some embodiments, the polyethylene terephthalate polymer chains characterized in that at least four of the ten carbon atoms in the repeat unit of the polymer chains are derived from ethanol comprise at least 10% of all polyethylene terephthalate polymer chains in the composition. In some embodiments, the polyethylene terephthalate polymer chains characterized in that at least four of the ten carbon atoms in the repeat unit of the polymer chains are derived from ethanol comprise at least 20%, at least 30%, at least 50%, at least 75%, or at least 90% of all polyethylene terephthalate polymer chains in the composition. In some embodiments, at least a fraction of the polyethylene terephthalate polymer chains contain ethylene terephthalate repeat units characterized in that the ethylene carbon atoms are derived from ethanol, but none of the aromatic ring carbons are derived from ethanol.

In another aspect, provided herein is a polymer composition comprising polyethylene terephthalate polymer chains wherein four of the ten carbon atoms in at least a fraction of the ethylene terephthalate repeat units in the polymer chains are derived from ethanol.

In some embodiments, the four carbon atoms derived from ethanol include the two methylene carbon atoms in the ethylene glycol unit, and two of the carbon atoms in the aromatic ring.

In some embodiments, one of the carbon atoms in the aromatic ring that is derived from ethanol is directly bonded to a carboxy group.

In some embodiments, one of the carbon atoms in the aromatic ring that is derived from ethanol is directly bonded to a hydrogen atom.
In some embodiments, the two carbon atoms in the aromatic ring derived from ethanol are adjacent to each other. In some embodiments, one of the two carbon atoms in the aromatic ring derived from ethanol is directly bonded to a carboxy group. In some embodiments, the carbon atoms in the aromatic ring derived from ethanol are not both directly bonded to hydrogen atoms.

In some embodiments, the polymer composition is characterized in the composition contains a mixture of terephthalic acid moieties that differ with respect to the position of the carbon atoms that are derived from ethanol in the aromatic rings.

In some embodiments, the composition comprises a mixture of polyethylene terephthalate polymer chains, some of which are characterized in that at least four of the ten carbon atoms in the repeat unit of the polymer chains are derived from ethanol, and some of which are characterized in that two or fewer of the ten carbon atoms in the repeat unit of the polymer chains are derived from ethanol. In some embodiments, the polyethylene terephthalate polymer chains characterized in that at least four of the ten carbon atoms in the repeat unit of the polymer chains are derived from ethanol comprise at least 10% of the polyethylene terephthalate polymer chains in the composition. In some embodiments, the polyethylene terephthalate polymer chains characterized in that at least four of the ten carbon atoms in the repeat unit of the polymer chains are derived from ethanol comprise at least 20%, at least 30%, at least 50%, at least 75%, or at least 90% of all polyethylene terephthalate polymer chains in the composition. In some embodiments, at least a fraction of the polyethylene terephthalate polymer chains contain ethylene terephthalate repeat units characterized in that the ethylene carbon atoms are derived from ethanol, but none of the aromatic ring carbons are derived from ethanol.

In another aspect, the present invention provides a polymer composition comprising polyethylene terephthalate polymer chains, the composition characterized in that, in at least a fraction of the polymer chains, at least two of the carbon atoms in the aromatic ring of each ethylene terephthalate repeat unit in the polymer chains are derived from ethanol.

In another aspect, the present invention provides a polymer composition comprising polyethylene terephthalate polymer chains wherein two of the carbon atoms in the aromatic ring of at least a fraction of the ethylene terephthalate repeat units in the polymer chains are derived from ethanol.

In another aspect, the present invention provides a polymer composition comprising polyethylene terephthalate polymer chains, the composition characterized in that four of the ten carbon atoms in at least a fraction of the ethylene terephthalate repeat units in the composition are derived from ethanol.

In some embodiments, the ethanol is derived from a biological source (i.e., a biobased ethanol). In some embodiments, the biobased ethanol has a biobased content of 100%. In some embodiments, the biobased ethanol has a pMC of 107.5.

In some embodiments, the carboxy carbon atoms of the PET are derived from carbon monoxide that is present in the ethanol-involved terephthalic acid production.

In some embodiments, provided herein is a polymer composition comprising polyethylene terephthalate polymer chains, wherein the polymer chains comprise at least one ethylene terephthalate repeat unit having a pMC of greater than zero. In some embodiments, the polymer chains comprise at least one ethylene terephthalate repeat unit having a pMC of between zero and about 21.5. In some embodiments, the polymer chains comprise at least one ethylene terephthalate repeat unit having a pMC of at least about 21.5. In some embodiments, the polymer chains comprise at least one ethylene terephthalate repeat unit having a pMC of between about 21.5 and about 43. In some embodiments, the polymer chains comprise at least one ethylene terephthalate repeat unit having a pMC of about 43.

In some embodiments, provided herein is a polymer composition comprising polyethylene terephthalate polymer chains, wherein the polymer chains comprise at least one ethylene terephthalate repeat unit having a biobased content of greater than zero. In some embodiments, the polymer chains comprise at least one ethylene terephthalate repeat unit having a biobased content of between zero and about 20%. In some embodiments, the polymer chains comprise at least one ethylene terephthalate repeat unit having a biobased content of at least about 20%. In some embodiments, the polymer chains comprise at least one ethylene terephthalate repeat unit having a biobased content of between about 20% and about 40%. In some embodiments, the polymer chains comprise at least one ethylene terephthalate repeat unit having a biobased content of about 40%.

In another aspect, provided herein is a plastic molding composition comprising a PET polymer composition described herein.

In another aspect, provided herein is a manufactured good comprising a PET polymer composition described herein. In some embodiments, the polymer composition is present in a fiber. In some embodiments, the good comprises a carpet. In some embodiments, the good comprises a fabric. In some embodiments, the good comprises a packaging material. In some embodiments, the packaging material comprises a bottle.

PTT Compositions, and Plastic Molding Compositions and Manufactured Goods Thereof

In one aspect, provided herein is a polymer composition comprising polytrimethylene terephthalate (PTT) polymer chains, the composition characterized in that, in at least a fraction of the polymer chains, four of the eleven carbon atoms in each trimethylene terephthalate repeat unit of the polymer chains are derived from ethanol.

In some embodiments, the four carbon atoms derived from ethanol include the two methylene carbon atoms in the trimethylene moiety, and two of the carbon atoms in the aromatic ring of the terephthalate moiety. In some embodiments, the composition contains a mixture of trimethylene terephthalate repeat units that differ with respect to the position of the carbon atoms that are derived from ethanol in the aromatic rings.

In some embodiments, one of the carbon atoms in the aromatic ring that is derived from ethanol is directly bonded to a carboxy group.

In some embodiments, one of the carbon atoms in the aromatic ring that is derived from ethanol is directly bonded to a hydrogen atom.

In some embodiments, the two carbon atoms in the aromatic ring derived from ethanol are adjacent to each other in the ring. In some embodiments, one of the two carbon atoms in the aromatic ring derived from ethanol is directly bonded to a carboxy group. In some embodiments, the polymer composition comprises trimethylene terephthalate repeat units wherein the carbon atoms in the aromatic ring derived from ethanol are not both directly bonded to hydrogen atoms.

In some embodiments, the composition comprises a mixture of polytrimethylene terephthalate polymer chains, some of which are characterized in that at least four of the eleven carbon atoms in the repeat unit of the polymer chains are derived from ethanol, and some of which are characterized in that two or fewer of the eleven carbon atoms in the repeat unit of the polymer chains are derived from ethanol. In some embodiments, the polytrimethylene terephthalate polymer chains characterized in that at least four of the eleven carbon atoms in the repeat unit of the polymer chains are derived from ethanol comprise at least 10% of all polytrimethylene terephthalate polymer chains in the composition. In some embodiments, the polytrimethylene terephthalate polymer chains characterized in that at least four of the eleven carbon atoms in the repeat unit of the polymer chains are derived from ethanol comprise at least 20%, at least 30%, at least 50%, at least 75%, or at least 90% of all polytrimethylene terephthalate polymer chains in the composition. In some embodiments, at least a fraction of the polytrimethylene terephthalate polymer chains contain trimethylene terephthalate repeat units characterized in that two of the three trimethylene carbon atoms are derived from ethanol, but none of the aromatic ring carbons are derived from ethanol.

In another aspect, provided herein is a polymer composition comprising polytrimethylene terephthalate polymer chains wherein four of the eleven carbon atoms in at least a fraction of the trimethylene terephthalate repeat units in the polymer chains are derived from ethanol.

In some embodiments, the four carbon atoms derived from ethanol include the two methylene carbon atoms in the trimethylene glycol unit, and two of the carbon atoms in the aromatic ring.

In some embodiments, one of the carbon atoms in the aromatic ring that is derived from ethanol is directly bonded to a carboxy group.

In some embodiments, one of the carbon atoms in the aromatic ring that is derived from ethanol is directly bonded to a hydrogen atom.

In some embodiments, the two carbon atoms in the aromatic ring derived from ethanol are adjacent to each other. In some embodiments, one of the two carbon atoms in the aromatic ring derived from ethanol is directly bonded to a carboxy group. In some embodiments, the carbon atoms in the aromatic ring derived from ethanol are not both directly bonded to hydrogen atoms.

In some embodiments, the polymer composition is characterized in the composition contains a mixture of terephthalic acid moieties that differ with respect to the position of the carbon atoms that are derived from ethanol in the aromatic rings.

In some embodiments, the composition comprises a mixture of polytrimethylene terephthalate polymer chains, some of which are characterized in that at least four of the eleven carbon atoms in the repeat unit of the polymer chains are derived from ethanol, and some of which are characterized in that two or fewer of the eleven carbon atoms in the repeat unit of the polymer chains are derived from ethanol. In some embodiments, the polytrimethylene terephthalate polymer chains characterized in that at least four of the eleven carbon atoms in the repeat unit of the polymer chains are derived from ethanol comprise at least 10% of the polytrimethylene terephthalate polymer chains in the composition. In some embodiments, the polytrimethylene terephthalate polymer chains characterized in that at least four of the eleven carbon atoms in the repeat unit of the polymer chains are derived from ethanol comprise at least 20%, at least 30%, at least 50%, at least 75%, or at least 90% of all polytrimethylene terephthalate polymer chains in the composition. In some embodiments, at least a fraction of the polytrimethylene terephthalate polymer chains contain trimethylene terephthalate repeat units characterized in that two of the three trimethylene carbon atoms are derived from ethanol, but none of the aromatic ring carbons are derived from ethanol.

In another aspect, the present invention provides a polymer composition comprising polytrimethylene terephthalate polymer chains, the composition characterized in that, in at least a fraction of the polymer chains, at least two of the carbon atoms in the aromatic ring of each trimethylene terephthalate repeat unit in the polymer chains are derived from ethanol.

In another aspect, the present invention provides a polymer composition comprising polytrimethylene terephthalate polymer chains wherein two of the carbon atoms in the aromatic ring of at least a fraction of the trimethylene terephthalate repeat units in the polymer chains are derived from ethanol.

In another aspect, the present invention provides a polymer composition comprising polytrimethylene terephthalate polymer chains, the composition characterized in that four of the eleven carbon atoms in at least a fraction of the trimethylene terephthalate repeat units in the composition are derived from ethanol.

In some embodiments, the ethanol is derived from a biological source. (i.e., a biobased ethanol). In some embodiments, the biobased ethanol has a biobased content of 100%. In some embodiments, the biobased ethanol has a pMC of 107.5.

In some embodiments, the carboxy carbon atoms of the PTT are derived from carbon monoxide that is present in the ethanol-involved terephthalic acid production.

In some embodiments, provided herein is a polymer composition comprising polytrimethylene terephthalate polymer chains, wherein the polymer chains comprise at least one trimethylene terephthalate repeat unit having a pMC of greater than zero. In some embodiments, the polymer chains comprise at least one trimethylene terephthalate repeat unit having a pMC of between zero and about 19.5. In some embodiments, the polymer chains comprise at least one trimethylene terephthalate repeat unit having a pMC of at least about 19.5. In some embodiments, the polymer chains comprise at least one trimethylene terephthalate repeat unit having a pMC of between about 19.5 and about 39. In some embodiments, the polymer chains comprise at least one trimethylene terephthalate repeat unit having a pMC of about 39.

In some embodiments, provided herein is a polymer composition comprising polytrimethylene terephthalate polymer chains, wherein the polymer chains comprise at least one trimethylene terephthalate repeat unit having a biobased content of greater than zero. In some embodiments, the polymer chains comprise at least one trimethylene terephthalate repeat unit having a biobased content of between zero and about 18.2%. In some embodiments, the polymer chains comprise at least one trimethylene terephthalate repeat unit having a biobased content of at least about 18.2%. In some embodiments, the polymer chains comprise at least one trimethylene terephthalate repeat unit having a biobased content of between about 18.2% and about 36.4%. In some embodiments, the polymer chains comprise at least one trimethylene terephthalate repeat unit having a biobased content of about 36.4%.

In another aspect, provided herein is a plastic molding composition comprising a PTT polymer composition described herein.

In another aspect, provided herein is a manufactured good comprising a PTT polymer composition described herein. In some embodiments, the polymer composition is present in a fiber. In some embodiments, the good comprises a carpet. In some embodiments, the good comprises a fabric. In some embodiments, the good comprises a packaging material. In some embodiments, the packaging material comprises a bottle.

PBT Compositions, and Plastic Molding Compositions and Manufactured Goods Thereof

In one aspect, provided herein is a polymer composition comprising polybutylene terephthalate (PBT) polymer chains, the composition characterized in that, in at least a fraction of the polymer chains, four of the twelve carbon atoms in each butylene terephthalate repeat unit of the polymer chains are derived from ethanol.

In some embodiments, the four carbon atoms derived from ethanol include the two methylene carbon atoms in the butylene moiety, and two of the carbon atoms in the aromatic ring of the terephthalate moiety. In some embodiments, the composition contains a mixture of butylene terephthalate repeat units that differ with respect to the position of the carbon atoms that are derived from ethanol in the aromatic rings.

In some embodiments, one of the carbon atoms in the aromatic ring that is derived from ethanol is directly bonded to a carboxy group.

In some embodiments, one of the carbon atoms in the aromatic ring that is derived from ethanol is directly bonded to a hydrogen atom.

In some embodiments, the two carbon atoms in the aromatic ring derived from ethanol are adjacent to each other in the ring. In some embodiments, one of the two carbon atoms in the aromatic ring derived from ethanol is directly bonded to a carboxy group. In some embodiments, the polymer composition comprises butylene terephthalate repeat units wherein the carbon atoms in the aromatic ring derived from ethanol are not both directly bonded to hydrogen atoms.

In some embodiments, the composition comprises a mixture of polybutylene terephthalate polymer chains, some of which are characterized in that at least four of the twelve carbon atoms in the repeat unit of the polymer chains are derived from ethanol, and some of which are characterized in that two or fewer of the twelve carbon atoms in the repeat unit of the polymer chains are derived from ethanol. In some embodiments, the polybutylene terephthalate polymer chains characterized in that at least four of the twelve carbon atoms in the repeat unit of the polymer chains are derived from ethanol comprise at least 10% of all polybutylene terephthalate polymer chains in the composition. In some embodiments, the polybutylene terephthalate polymer chains characterized in that at least four of the twelve carbon atoms in the repeat unit of the polymer chains are derived from ethanol comprise at least 20%, at least 30%, at least 50%, at least 75%, or at least 90% of all polybutylene terephthalate polymer chains in the composition. In some embodiments, at least a fraction of the polybutylene terephthalate polymer chains contain butylene terephthalate repeat units characterized in that two of the four butylene carbon atoms are derived from ethanol, but none of the aromatic ring carbons are derived from ethanol.

In another aspect, provided herein is a polymer composition comprising polybutylene terephthalate polymer chains wherein four of the twelve carbon atoms in at least a fraction of the butylene terephthalate repeat units in the polymer chains are derived from ethanol.

In some embodiments, the four carbon atoms derived from ethanol include the two methylene carbon atoms in the butylene glycol unit, and two of the carbon atoms in the aromatic ring.

In some embodiments, one of the carbon atoms in the aromatic ring that is derived from ethanol is directly bonded to a carboxy group.

In some embodiments, one of the carbon atoms in the aromatic ring that is derived from ethanol is directly bonded to a hydrogen atom.

In some embodiments, the two carbon atoms in the aromatic ring derived from ethanol are adjacent to each other. In some embodiments, one of the two carbon atoms in the aromatic ring derived from ethanol is directly bonded to a carboxy group. In some embodiments, the carbon atoms in the aromatic ring derived from ethanol are not both directly bonded to hydrogen atoms.

In some embodiments, the polymer composition is characterized in the composition contains a mixture of terephthalic acid moieties that differ with respect to the position of the carbon atoms that are derived from ethanol in the aromatic rings.

In some embodiments, the composition comprises a mixture of polybutylene terephthalate polymer chains, some of which are characterized in that at least four of the twelve carbon atoms in the repeat unit of the polymer chains are derived from ethanol, and some of which are characterized in that two or fewer of the twelve carbon atoms in the repeat unit of the polymer chains are derived from ethanol. In some embodiments, the polybutylene terephthalate polymer chains characterized in that at least four of the twelve carbon atoms in the repeat unit of the polymer chains are derived from ethanol comprise at least 10% of the polybutylene terephthalate polymer chains in the composition. In some embodiments, the polybutylene terephthalate polymer chains characterized in that at least four of the twelve carbon atoms in the repeat unit of the polymer chains are derived from ethanol comprise at least 20%, at least 30%, at least 50%, at least 75%, or at least 90% of all polybutylene terephthalate polymer chains in the composition. In some embodiments, at least a fraction of the polybutylene terephthalate polymer chains contain butylene terephthalate repeat units characterized in that two of the four butylene carbon atoms are derived from ethanol, but none of the aromatic ring carbons are derived from ethanol.

In another aspect, the present invention provides a polymer composition comprising polybutylene terephthalate polymer chains, the composition characterized in that, in at least a fraction of the polymer chains, at least two of the carbon atoms in the aromatic ring of each butylene terephthalate repeat unit in the polymer chains are derived from ethanol.

In another aspect, the present invention provides a polymer composition comprising polybutylene terephthalate polymer chains wherein two of the carbon atoms in the aromatic ring of at least a fraction of the butylene terephthalate repeat units in the polymer chains are derived from ethanol.

In another aspect, the present invention provides a polymer composition comprising polybutylene terephthalate polymer chains, the composition characterized in that four of the twelve carbon atoms in at least a fraction of the butylene terephthalate repeat units in the composition are derived from ethanol.

In some embodiments, the ethanol is derived from a biological source. (i.e., a biobased ethanol). In some embodiments, the biobased ethanol has a biobased content of 100%. In some embodiments, the biobased ethanol has a pMC of 107.5.

In some embodiments, the carboxy carbon atoms of the PBT are derived from carbon monoxide that is present in the ethanol-involved terephthalic acid production.

In some embodiments, provided herein is a polymer composition comprising polybutylene terephthalate polymer chains, wherein the polymer chains comprise at least one butylene terephthalate repeat unit having a pMC of greater than zero. In some embodiments, the polymer chains comprise at least one butylene terephthalate repeat unit having a pMC of between zero and about 17.9. In some embodiments, the polymer chains comprise at least one butylene terephthalate repeat unit having a pMC of at least about 17.9. In some embodiments, the polymer chains comprise at least one butylene terephthalate repeat unit having a pMC of between about 17.9 and about 35.8. In some embodiments, the polymer chains comprise at least one butylene terephthalate repeat unit having a pMC of about 35.8.

In some embodiments, provided herein is a polymer composition comprising polybutylene terephthalate polymer chains, wherein the polymer chains comprise at least one butylene terephthalate repeat unit having a biobased content of greater than zero. In some embodiments, the polymer chains comprise at least one butylene terephthalate repeat unit having a biobased content of between zero and about 16.7%. In some embodiments, the polymer chains comprise at least one butylene terephthalate repeat unit having a biobased content of at least about 16.7%. In some embodiments, the polymer chains comprise at least one butylene terephthalate repeat unit having a biobased content of between about 16.7% and about 33.4%. In some embodiments, the polymer chains comprise at least one butylene terephthalate repeat unit having a biobased content of about 33.3%.

In another aspect, provided herein is a plastic molding composition comprising a PBT polymer composition described herein.

In another aspect, provided herein is a manufactured good comprising a PBT polymer composition described herein. In some embodiments, the polymer composition is present in a fiber. In some embodiments, the good comprises a carpet. In some embodiments, the good comprises a fabric. In some embodiments, the good comprises a packaging material. In some embodiments, the packaging material comprises a bottle.

What is claimed is:

1. A polymer composition comprising polyalkylene terephthalate polymer chains, the composition characterized in that, in at least a 10% of the polymer chains, at least two of the carbon atoms in each alkylene terephthalate repeat unit of the polymer chains are derived from ethanol and the polyalkylene terephthalate polymer chains consist of polyethylene terephthalate polymer chains having 10 carbon atoms in polythylene terephthalate repeat units; polytrimethylene terephthalate polymer chains having 11 carbon atoms in polytrimethylene terephthalate repeat units; or polybutylene terephthalate polymer chains having 12 carbon atoms in polybutylene terephthalate repeat units.

2. The polymer composition of claim 1, wherein in the at least a 10% of the polymer chains the at least two carbons atoms in each repeat unit are in the aromatic ring.

3. The polymer composition of claim 1, wherein in the at least a 10% of the polymer chains at least four of the carbon atoms in each alkylene terephthalate repeat unit of the polymer chains are derived from ethanol.

4. The polymer composition of claim 3, wherein the at least four carbon atoms derived from ethanol include two methylene carbon atoms in the alkylene moiety, and two of the carbon atoms in the aromatic ring of the terephthalate moiety.

5. The polymer composition of claim 2, wherein one of the carbon atoms in the aromatic ring that is derived from ethanol is directly bonded to a carboxy group or to a hydrogen atom.

6. The polymer composition of claim 2, wherein the at least two carbon atoms in the aromatic ring derived from ethanol are adjacent to each other in the ring.

7. The polymer composition of claim 2, wherein one of the at least two carbon atoms in the aromatic ring derived from ethanol is directly bonded to a carboxy group.

8. The polymer composition of claim 2, wherein the carbon atoms in the aromatic ring derived from ethanol are not both directly bonded to hydrogen atoms.

9. The polymer composition of claim 2, wherein the composition contains a mixture of alkylene terephthalate repeat units that differ with respect to the position of the carbon atoms that are derived from ethanol in the aromatic rings.

10. The polymer composition of claim 1, wherein the polyalkylene terephthalate polymer chains characterized in that at least two of the carbon atoms in the repeat unit of the polymer chains are derived from ethanol comprise at least 20%, at least 30%, at least 50%, at least 75%, or at least 90% of all polyalkylene terephthalate polymer chains in the composition.

11. The polymer composition of claim 10, wherein the polyalkylene terephthalate polymer chains contain terephthalate repeat units characterized in that the alkylene carbon atoms are derived from ethanol, but none of the aromatic ring carbons are derived from ethanol.

12. The polymer composition of claim 3, wherein the at least four carbon atoms derived from ethanol include the two methylene carbon atoms in the alkylene glycol unit, and two of the carbon atoms in the aromatic ring.

13. A polymer composition comprising polyalkylene terephthalate polymer chains, the composition characterized in that, in at least a 10% of the polymer chains, at least four of the carbon atoms in each alkylene terephthalate repeat unit of the polymer chains are derived from ethanol and the polyalkylene terephthalate polymer chains consist of polyethylene terephthalate polymer chains having 10 carbon atoms in polythylene terephthalate repeat units; polytrimethylene terephthalate polymer chains having 11 carbon atoms in polytrimethylene terephthalate repeat units; or polybutylene terephthalate polymer chains having 12 carbon atoms in polybutylene terephthalate repeat units.

14. The polymer composition of claim 13, wherein one of the carbon atoms that is derived from ethanol is directly bonded to a carboxy group or to a hydrogen atom.

15. The polymer composition of claim 13, wherein at least two carbon atoms in the aromatic ring are derived from ethanol and are adjacent to each other in the ring.

16. The polymer composition of claim 15, wherein one of the two carbon atoms in the aromatic ring derived from ethanol is directly bonded to a carboxy group.

17. The polymer composition of claim 14, wherein the carbon atoms in the aromatic ring derived from ethanol are not both directly bonded to hydrogen atoms.

18. A polymer composition comprising polyethylene terephthalate polymer chains wherein four of the ten carbon atoms in at least 10% of the ethylene terephthalate repeat units in the polymer chains are derived from ethanol.

19. The polymer composition of claim 18 wherein the ethanol is derived from a biological source.

20. The polymer composition of claim 18, wherein the carboxy carbon atoms of the polyethylene terephthalate polymer chains are derived from carbon dioxide.

21. A polymer composition comprising polyethylene terephthalate polymer chains wherein at least two of the carbon atoms in the aromatic ring of at least 10% of the ethylene terephthalate repeat units in the polymer chains are derived from ethanol.

22. The polymer composition of claim 21 wherein the ethanol is derived from a biological source.

23. The polymer composition of claim 21, wherein the carboxy carbon atoms of the polyethylene terephthalate polymer chains are derived from carbon dioxide.

24. A polymer composition comprising polytrimethylene terephthalate polymer chains wherein four of the eleven carbon atoms in at least 10% of the trimethylene terephthalate repeat units in the polymer chains are derived from ethanol.

25. The polymer composition of claim 24 wherein the ethanol is derived from a biological source.

26. The polymer composition of claim 24, wherein the carboxy carbon atoms of the polytrimethylene terephthalate are derived from carbon dioxide.

27. A polymer composition comprising polytrimethylene terephthalate polymer chains, wherein four of the eleven carbon atoms in at least 10% of the trimethylene terephthalate repeat units in the composition are derived from ethanol.

28. The polymer composition of claim 27 wherein the ethanol is derived from a biological source.

29. The polymer composition of claim 27, wherein the carboxy carbon atoms of the polytrimethylene terephthalate are derived from carbon dioxide.

30. A polymer composition comprising polybutylene terephthalate polymer chains wherein at least in at least 10% of the polymer chains, four of the twelve carbon atoms in each butylene terephthalate repeat unit of the polymer chains are derived from ethanol.

31. The polymer composition of claim 30 wherein the ethanol is derived from a biological source.

32. The polymer composition of any of claim 30 wherein the carboxy carbon atoms of the polybutylene terephthalate are derived from carbon dioxide.

33. A polymer composition comprising polybutylene terephthalate polymer chains wherein at least two of the carbon atoms in the aromatic ring of each butylene terephthalate repeat unit in the polymer chains are derived from ethanol.

34. The polymer composition of claim 33 wherein the ethanol is derived from a biological source.

35. The polymer composition of claim 33 wherein the carboxy carbon atoms of the polybutylene terephthalate are derived from carbon dioxide.
